(19) United States
(12) Patent Application Publication
(10) Pub. No.: US 2003/0198731 A1
(43) Pub. Date: Oct. 23, 2003

(54) Method for producing soft dog chews

(76) Inventors: Shiping Zhang, Tianjin (CN); Dayuan Jin, Tianjin (CN)

Correspondence Address: Judson K. Champlin, WESTMAN CHAMPLIN & KELLY, International Centre - Suite 1600, 900 South Second Avenue, Minneapolis, MN, 55402-3319, US

(21) Appl. No.: 10/223,406

(22) Filed: Aug. 19, 2002

(30) Foreign Application Priority Data
Apr. 22, 2002 (CN) 02117250.1

(51) Int. Cl. A23L 1/31

(52) U.S. Cl. 426/641

(57) ABSTRACT

The present invention relates to a method for producing a kind of food for animal, particularly, a method for producing a chew for a pet dog with edible soft hide. A method for producing dog chew including: a step for washing impurity contents away from the fresh second-layer hide; a step for washing the fresh second-layer hide with ammonium sulfate solution; a step for washing the fresh second layer hide until value of Ph reaches 7.0; a step for washing the fresh second-layer hide in hydrogen peroxide solution for disinfecting and bleaching; a step for squeezing out water; a step for soaking the second-layer hide in the fluid mixture of edible glycerin, sorbitol and water; a step for drying the fresh second-layer hide in the air and forming into predetermined shapes; a step for drying the formed the dog chew in the air; and a step for disinfecting and packing. According to the method of the present invention, a dog chew which is effective on tartar control and cleanliness of the mouth of a pet dog is produced.

### BACKGROUND OF THE INVENTION

1. The Technical Field of the Invention

The present invention relates to a method for producing a kind of food for animal, and particularly relates to a method for producing a chew for a pet dog with edible soft hide.

2. The Technical Background

In the conventional method for producing the pet dog's chew the rubber is generally used, the surface of the dog chew is covered with cone-shaped protuberances to help clean the mouth as well as the teeth of the dog. However, this kind of dog chew is neither edible nor effective on tartar control, and it turns out to be unattractive to a dog in quite a short time.

There has been another method for producing a dog's chew in which the knotted bones or pressed bones as well as bones in other shapes are made of the second layer of oxhide or hoghide. However, this method for producing the dog chews involves an indispensable drying step, the dog chews made in this way are stiff, so that they are not only difficult for a little pet dog to gnaw at but also ineffective on tartar control of the dog.

### SUMMARY OF THE INVENTION

The present invention has been made to solve the above-described problems. Accordingly, the object of the present invention is to provide a technology with use of which it becomes possible to produce a dog chew which is not only easy for a dog to gnaw at but also effective on tartar control of the dog.

In order to achieve the above-described objects of the present invention, the method for producing a dog chew is implemented as described hereinafter.

A method for producing dog chew including:

1. A step for washing impurity contents away from the fresh second-layer hide with flowing clean water in a revolving wooden drum for about half an hour to an hour.

2. A step for washing the fresh second layer hide with 4-6% ammonium sulfate solution in a revolving wooden drum for about one and a half hour to two and a half hours for the neutralization of alkalinity in the hide.

3. A step for washing the fresh second layer hide with flowing clean water in the revolving wooden drum until the value of Ph reaches 7.

4. A step for washing the fresh second layer hide obtained from step 3 with 15-25% in concentration of hydrogen peroxide solution in the revolving wooden drum for one to two hours, comprising a step for keeping the hide in static stade in hydrogen peroxide solution inside the wooden drum for eight to ten hours, whereby the fresh second layer hide is completely disinfected and bleached.

5. A step for taking the fresh second-layer hide out of the wooden drum and squeezing the water out by use of, for example, a squeezer.

6. A step for soaking the second-layer hide in the fluid mixture of edible glycerin, sorbitol and water in which the ratio of the above is 20-40:40-80:80-150 respectively.

7. A step for drying the fresh second-layer hide in the open air for about six to eight hours and then cutting and forming it into predetermined shape.

8. A step for drying the formed dog chews in the open air until no fluid used in step 6 is remained on the surface of the dog chew.

9. A step for disinfecting the dog chew in ultraviolet ray and packing it.

A method for producing a dog chew as described above wherein the fresh second-layer hide is fresh second-layer hide of oxhide or hoghide.

According to the above-described method for producing dog chews of the present invention, the soft dog chew is soaked into the mixture of edible glycerin and sorbitol for keeping the dog chews soft and pliable, so that it is very easy for a pet dog to gnaw at it and to digest it.

Furthermore, deformation is liable to occur when a pet dog gnaws at it, resulting in larger area of the dogs' mouth contacting with the dog chew compared with a conventional one, thereby the dog chew turn out to be effective on tartar control and cleanliness of the mouth of a pet dog.

Moreover, the method for producing dog chews according to the present invention is implemented in a simple way without special equipment and the raw material such as oxhide or hoghide is easily obtained.

### DESCRIPTION OF THE PREFERRED EMBODIMENTS

In the following, preferred embodiments of the present invention will be described in detail.

A method for producing a dog chew according to the present invention generally includes nine steps which are explained hereinafter.

Step 1: In this step, firstly, the second-layer of hoghide is put into the revolving wooden drum wherein the fluid inflow port is connected with fresh water input pipe, and a grilled cover is disposed on the top of the inlet of raw material. Clean water is fed continuously into the drum while it's revolving, at the same time; the waste water is discharged outside the drum through the grilled cover. In this step, the impurity contents on the surface of the second-layer hide is removed by the flowing clean water. In this case, the alkalinity in the second-layer hide mainly comprise calcium bicarbonate and dust that are left over while the hair on the hoghide has been removed and the first-layer hide has been cut off from the hide.

Step 2: In this step, firstly, the drum is drained out of water and a cover is put on the inlet of raw material of the drum to seal it. Then, 5% ammonium sulfate solution is imported into the drum and the second-layer hide in the revolving drum is washed in the same way as conducted in step 1 with ammonium sulfate solution for two hours. In this step, ash, namely the substance contained inside the inner layer of the hide, is completely washed away from the second-layer hide whereas the calcium bicarbonate reacts chemically with ammonium sulfate, thus turning to be calcium carbonate and water which can be easily washed away. In addition, the fat content of the second-layer of hide decreases in the washing process.

Step 3: In this step, the same process as the step 1 is applied to the second-layer of hide after the process in step 2 has been conducted until the value of Ph reaches 7. In this case, a test for value of Ph is conducted by sticking the test paper of alkali and acid on the surface of the second layer hide. Meanwhile, it's preferred to make the value of Ph reach to 7, at which the hide will be in compliance with the requirements of food for animal.

Step 4: In this step, 15% in concentration of hydrogen peroxide solution is imported into the revolving drum from the inflow port. The second-layer hide is washed with the flowing solution in the same way as step 3 in the revolving drum for one hour. Then, the second-layer hide is kept in a static state for eight hours whereas the aforesaid hide is disinfected and bleached.

Step 5: In this step, the second-layer hide is draw out of the drum and a squeezing process is conducted wherein a squeezer is used.

Step 6: In this step, the second-layer hide is soaked in a mixture of edible glycerin, sorbitol and water inside a container wherein the ratio of the above components is 30:30:150, respectively. In this case, the sorbitol in the mixture functions for moisture preservation and antisepsis except for adding a sweet flavour in the hide.

Step 7: In this step, the second-layer hide is drawn out of the container and water is filtered out. Then, the hide is dried in the open air for six to eight hours. In the end, the hide is cut in accordance with predetermined patterns and made into predetermined shapes.

Step 8: In this step, the dog chew obtained from the above-described step is dried in hot air so that no moisture of the solution utilized in step 6 is remained on the surface of the dog chew.

Step 9: In this step, the dog chew dried in the above-described step is disinfected with ultraviolet ray and it is packed thereafter.

While the second-layer hide of hoghide is used in this case, the invention is not limited thereto, but the second-layer of oxhide can be used to achieve the same result.

What is claimed is:

1. A method for producing dog chew including:
A step for washing impurity content away from the fresh second-layer hide with flowing clean water in a revolving wooden drum for about half an hour to an hour;
A step for washing the fresh second layer hide with 4-6% in concentration of ammonium sulfate solution inside a revolving wooden drum for about one and a half hour to two and a half hours for the neutralization of alkalinity in the hide. A step for washing the fresh second layer hide with flowing clean water in the revolving wooden drum until the value of Ph reaches 7;
A step for washing the fresh second layer hide obtained from step 3 in 15-25% in concentration of hydrogen peroxide solution inside said revolving wooden drum for one to two hours, comprising a following step for keeping the hide in static state in the wooden drum in hydrogen peroxide solution for eight to ten hours, whereby the fresh second layer hide is completely disinfected and bleached;
A step for taking the fresh second-layer hide out of the wooden drum and squeezing the water out by use of, for example, a squeezer;
A step for soaking the second-layer hide in the fluid mixture of edible glycerin, sorbitol and water in which the ratio of the above components is 20-40:40-80:80-150, respectively;
A step for drying the fresh second-layer hide in the air for six to eight hours and then cutting and forming it into predetermined shape;
A step for drying the formed dog chew in the open air until no fluid used in step 6 is remained on the surface of the dog chew;
A step for disinfecting the dog chew in ultraviolet ray and packing it.

2. A method for producing dog chews as claimed in claim 1, wherein the fresh second-layer hide is fresh second-layer hide of oxhide or hoghide.
